(19) United States
(12) Patent Application Publication
(10) Pub. No.: US 2009/0268929 A1
(43) Pub. Date: Oct. 29, 2009

(54) VOICE OUTPUT DEVICE AND METHOD, PROGRAM, AND ROOM

(75) Inventors: Tetsujiro Kondo, Tokyo (JP); Junichi Shima, Kanagawa (JP); Akihiko Arimitsu, Kanagawa (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Sony Corporation, Minato-ku (JP)

(21) Appl. No.: 12/064,964

(22) PCT Filed: Aug. 23, 2006
(86) PCT No.: PCT/JP2006/316487

§ 371 Date: Feb. 27, 2008

(30) Foreign Application Priority Data
Sep. 2, 2005 (JP) 2005-254400

(51) Int. Cl. H04R 1/00; H04R 3/00

(52) U.S. Cl. 381/152; 381/162

(57) ABSTRACT

The present invention relates to a sound output device, method and program, and room capable of producing sounds from individual parts in a wide range of a vibrating member by appropriately vibrating the parts. A vibrating member 26A vibrates to thereby output sounds. A vibrator 27A is mounted to the vibrating member 26A, and vibrates the vibrating member 26A based on a first sound signal. A vibrating member 27B is mounted to the vibrating plate 26A such that a given space is formed between the vibrator 27A and the vibrating member 27B. The vibrating member 27B vibrates the vibrating member 26A based on a second sound signal to thereby appropriately vibrate individual parts of a wide range of the vibrating member 26A. Sounds can be produced from the individual parts. The present invention can be applied to a sound output device and to a room.

### TECHNICAL FIELD

The present invention relates to a sound output device and method, program, and room and, more particularly, to a sound output device and method, program, and room for outputting sounds.

### BACKGROUND ART

A screen-type speaker system having the functions of a loudspeaker and acting also as a screen for partitioning a room or putting up a board screen is being utilized.

A conventional screen-type speaker system has a vibrating member 14-1 on which a vibrator 13-1 is attached as shown in FIG. 1. A vibrator 13-2 is attached to a vibrating member 14-2.

The vibrator 13-1 vibrates the vibrating member 14-1 based on a sound signal to output sounds, the sound signal being produced by performing given signal processing on sounds gathered by a microphone 11-1 supplied from a signal processing portion 12-1. Also, the vibrator 13-2 vibrates the vibrating member 14-2 based on a sound signal to output sounds, the sound signal being produced by performing given signal processing on sounds which are gathered by a microphone 11-2 and which are supplied from a signal-processing portion 12-2, in the same way as the vibrator 13-1.

As described so far, the conventional screen-type speaker system outputs sounds by vibrating one vibrating member by means of one vibrator.

Furthermore, a sound reproduction system (for example, patent reference 1) is also available which has waterproof speakers and actuators mounted to members that are mounted to a non-bathtub member (such as wall panel, counter, and ceiling panel near the bathtub apron or bathtub in the bathroom) inside a bathroom. The waterproof speakers have vibrating members mounted to the ceiling panel or wall panel of the bathroom. The waterproof speakers reproduce medium- and high-frequency sounds. The actuators vibrate the member in the bathroom to reproduce low-frequency sounds.

[Patent reference 1] JP-A-2001-157642

### DISCLOSURE OF THE INVENTION

### Problem that the Invention is to Solve

However, the conventional screen-type speaker system has the problem that when sound is gathered, the system cannot output sounds in directions along which the microphones are not directed.

For example, in the conventional screen-type speaker system, sounds gathered by the microphone 11-1 are entered into the vibrator 13-1 to thereby vibrate the vibrating member 14-1, thus outputting sounds. Sounds gathered by the microphone 11-2 are entered into the vibrator 13-2 to thereby vibrate the vibrating member 14-2, thus outputting sounds. In this method, it is impossible to reproduce sounds existing midway between the microphone 11-1 and microphone 11-2. In the resulting acoustic field, sounds gathered by the microphone 11-1 and microphone 11-2, respectively, are arranged discretely. The user cannot have a feeling of vivid reality.

The sound reproduction device disclosed in JP-A-2001-157642 cannot output sound in directions in which no microphone is present during gathering of sound. Furthermore, the device is based on the assumption that the room is not a general room but a bathroom. Therefore, medium- and high-frequency sounds are reproduced by the waterproof speakers. Low-frequency sounds are reproduced by vibrating members by means of the actuators mounted to members inside the bathroom.

Furthermore, in general speakers, in a case where sounds between two speakers are created, sounds from the two speakers are mixed in air and, therefore, if the location deviates from a so-called sweet spot even slightly, the sounds give a sense of discomfort to the user or there is the possibility that a phenomenon in which sounds between the speakers are left out, called a hole-in-the-middle takes place.

The present invention has been made in view of these circumstances. Individual parts of a wide range of a vibrating member are appropriately vibrated such that the individual parts can produce sounds.

### Means for Solving the Problems

One aspect (first aspect) of the present invention is a sound output device in which a first and a second sound signals are converted into sounds and outputted. The sound output device has: a vibrating member that vibrates to thereby output the sounds; a first vibrator mounted to the vibrating member and vibrating the vibrating member based on the first sound signal; and a second vibrator mounted to the vibrating plate such that a given space is provided between the first vibrator and the second vibrator, the second vibrator vibrating the vibrating member based on the second sound signal.

It is possible to add processing means for performing given signal processing on the first sound signal and the second sound signal, respectively.

The processing means can be equipped with delay processing means for delaying the first sound signal and the second sound signal, respectively.

The processing means can be equipped with filter processing means for passing certain frequency-band components of the components of the first sound signal and the second sound signal.

The processing means can be equipped with gain adjustment processing means for adjusting the gains for the first sound signal and the second sound signal, respectively.

One aspect (first aspect) of the present invention is a method (program) of outputting sounds, comprising the steps of: arranging a vibrating member that vibrates to thereby output the sounds, a first vibrator mounted to the vibrating member and vibrating the vibrating member based on the first sound signal, and a second vibrator mounted to the vibrating plate such that a given space is provided between the first vibrator and the second vibrator and vibrating the vibrating member based on the second sound signal and performing given signal processing on the first sound signal and the second sound signal.

In one aspect (first aspect) of the present invention, there are provided: a vibrating member that vibrates to thereby output the sounds; a first vibrator mounted to the vibrating member and vibrating the vibrating member based on the first sound signal; a second vibrator mounted to the vibrating plate such that a given space is provided between the first vibrator and the second vibrator and vibrating the vibrating member based on the second sound signal.

One aspect (second aspect) of the present invention is a room partitioned by walls consisting of: a vibrating member that vibrates to thereby output the sounds; a first vibrator mounted to the vibrating member and vibrating the vibrating member based on the first sound signal; and a second vibrator mounted to the vibrating plate such that a given space is provided between the first vibrator and the second vibrator and vibrating the vibrating member based on the second sound signal.

It is possible to add processing means for performing given signal processing on the first sound signal and the second sound signal.

It is also possible to add detection means for detecting the position of the user. The processing means can perform given signal processing on the first sound signal and the second sound signal based on the detected position.

It is possible that the four sides are surrounded by the walls.

In one aspect (second aspect) of the present invention, it is partitioned by walls consisting of: a vibrating member that vibrates to thereby output the sounds; a first vibrator mounted to the vibrating member and vibrating the vibrating member based on the first sound signal; and a second vibrator mounted to the vibrating plate such that a given space is provided between the first vibrator and the second vibrator and vibrating the vibrating member based on the second sound signal.

### ADVANTAGES OF THE INVENTION

As described so far, according to one aspect (first aspect) of the present invention, sounds can be produced from individual parts of a wide range of the vibrating member by appropriately vibrating the individual parts.

According to one aspect (second aspect) of the present invention, sounds can be produced from individual parts of a wide range of the walls owing to the vibrating member by appropriately vibrating the individual parts.

### BRIEF DESCRIPTION OF THE DRAWINGS

FIG. 1 is a view illustrating a conventional screen-type speaker system.

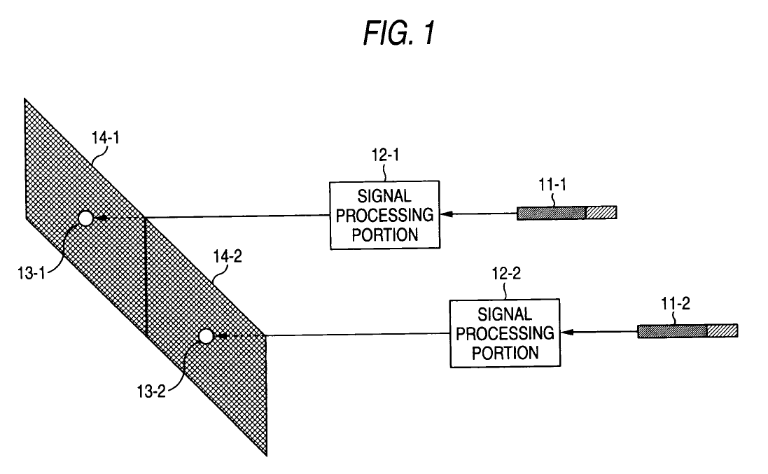

FIG. 2 is a view showing the outer appearance of the screen-type speaker system.

FIG. 3 is a block diagram showing the structure of one embodiment of a screen-type speaker system to which the present invention is applied.

FIG. 4 is a view illustrating an example in which microphones are mounted.

FIG. 5 is a diagram showing the structure of one embodiment of a room to which the present invention is applied.

FIG. 6 is a diagram illustrating vibrators mounted to a vibrating member.

FIG. 7 is a diagram in a case where the vibrating member of FIG. 6 is viewed from the front side.

FIG. 8 is a diagram illustrating details of delaying processing.

FIG. 9 is a diagram illustrating details of filtering processing.

FIG. 10 is a diagram illustrating details of a filtering processing portion.

FIG. 11 is a diagram illustrating details of a gain adjustment portion.

FIG. 12 is a view illustrating a vibrating plane.

FIG. 13 is a view illustrating enlargement of the range of the vibrating plane.

FIG. 14 is a flowchart illustrating processing for sound outputting.

FIG. 15 is a flowchart illustrating details of the signal processing of FIG. 14.

FIG. 16 is a block diagram showing an example of the structure of a personal computer.

### DESCRIPTION OF SYMBOLS

21, 21-1 to 21-12: screen-type speaker systems;
26, 26A to 26C, 26-1 to 26-12: vibrating members;
27, 27A to 27F, 27-1 to 27-M: vibrators;
41, 41-1 to 41-N: sound input terminals;
42, 42-1, 42-2: signal processing portions;
43: control portion; 44: sensor; 51: signal selection portion;
52: main processing portion;
53, 53-1 to 53-M: delay processing portions;
54, 54-1 to 54-M: filtering processing portions;
55, 55-1 to 55-M: gain adjustment portions;
71, 71-1 to 71-6: microphones;
72, 72-1 to 72-6: cables; 101: filter coefficient bank;
111: gain coefficient bank

### BEST MODE FOR CARRYING OUT THE INVENTION

Embodiments of the present invention are hereinafter described with reference to the drawings.

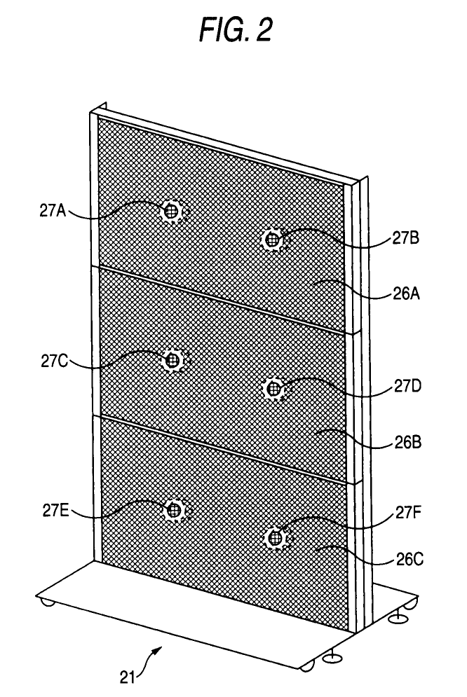

FIG. 2 is a view showing the outer appearance of a screen-type speaker system 21.

The screen-type speaker system 21 is one example of the sound output device of the present invention that serves the function of a speaker and acts also as a screen.

The screen-type speaker system 21 is designed to include vibrating members 26A to 26C and vibrators 27A to 27F.

Each of the vibrating members 26A to 26C is made of plaster board, MDF (medium density fiberboard), other kind of wood, aluminum plate, carbon, acrylic resin, other resin, or glass, for example, and is shaped into a flat plate. The vibrating members 26A to 26C may be made of a composite material in which different materials are combined or stacked on top of each other.

Plural vibrators (two vibrators in FIG. 2) are attached, for example, in a horizontal array on each of the vibrating members 26A to 26C. The vibrators 27A and 27B are attached in a horizontal array as viewed in the figure on the vibrating member 26A. The vibrator 27C and vibrator 27D are attached in a horizontal array as viewed in the figure on the vibrator 26B. The vibrator 27E and vibrator 27F are attached in a horizontal array on the vibrating member 26C.

The vibrators 27A to 27F vibrate the vibrating members 26A to 26C according to the sound signal supplied from a signal processing portion (described later). Consequently, the vibrating members 26A to 26C output sounds. That is, the screen-type speaker system 21 acts as a speaker for converting a sound signal into sounds.

The vibrators 27A to 27F are detachably placed into given positions according to the vibration characteristics of the vibrating members 26A to 26C, respectively.

In the example of FIG. 2, the screen-type speaker system 21 has the three vibrating members 26A-26C fixed thereto. In the present invention, the number of the vibrating members is not limited to three. One or plural vibrating members can be detachably held. In the screen-type speaker system 21, the vibrating members can be removed at will. Therefore, the user can modify the thickness (depth) of each vibrating member to a desired thickness.

In the following description, in a case where it is not necessary to discriminate between the individual vibrating members 26A-26C, they are simply referred to as vibrating members 26. Where it is not necessary to discriminate between the individual vibrators 27A-27F, they can be simply referred to as the vibrators 27.

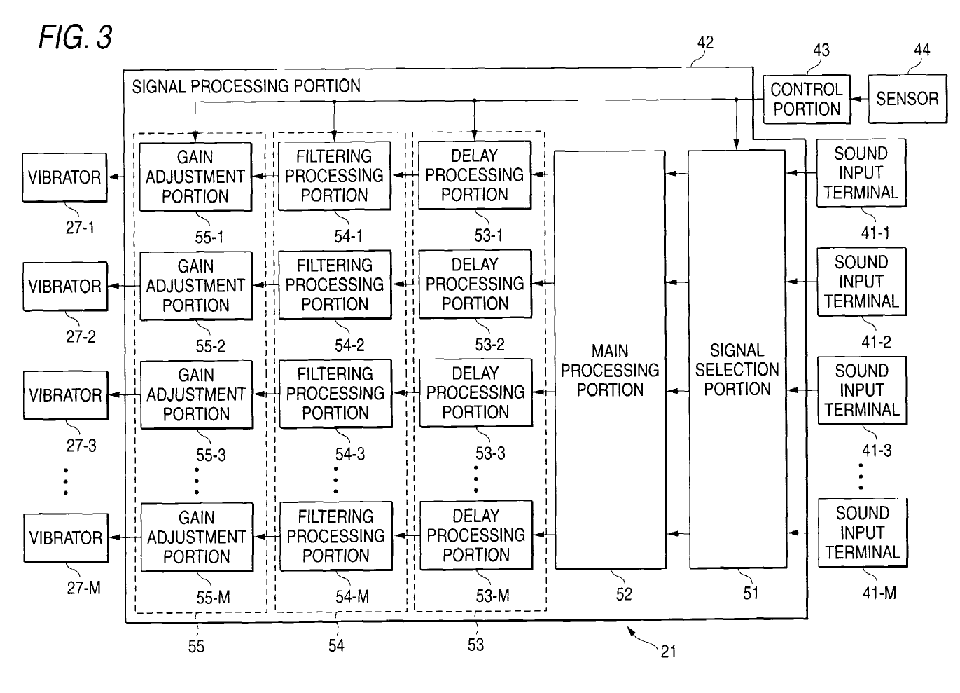

FIG. 3 is a block diagram showing the structure of one embodiment of the screen-type speaker system 21 to which the present invention is applied.

Those parts of FIG. 3 which are similar to their counterparts of FIG. 2 are indicated by identical symbols. The description is (appropriately) omitted.

For example, microphones (described later) are connected with sound input terminals 41-1 to 41-N, respectively. The sound input terminals 41-1 to 41-N supply sound signals, which are sound signals of sounds gathered by the microphones and are entered from the microphones, to the signal processing portion 42.

The signal processing portion 42 is, for example, made of a DSP (digital signal processor), MPU (microprocessing unit), or the like. The signal processing portion 42 performs given processing on sound signals entered from the sound input terminals 41-1 to 41-N under control of a control portion 43 and supplies sound signals obtained by the processing to the vibrators 27-1 to 27-M, respectively.

The control portion 43 controls the signal processing portion 42 by supplying a control signal to the signal processing portion 42.

The control portion 43 creates a control signal according to a signal supplied from a sensor 44 that detects the viewing and listening position of the user, and supplies the created control signal to the signal processing portion 42.

The sensor 44 is made of a mat sensor mounted on the floor, a microphone array, or a video camera, for example. The sensor detects the viewing and listening position of the user, based on a sound signal or video signal.

The vibrators 27-1 to 27-M vibrate the vibrating members 26 to which they are mounted, based on sound signals supplied from the signal processing portion 42. As a result, the vibrating member 26 outputs sounds.

The signal processing portion 42 is designed to include a signal selection portion 51, a main processing portion 52, delay processing portions 53-1 to 53-M, filtering processing portions 54-1 to 54-M, and gain adjustment portions 55-1 to 55-M.

The signal selection portion 51 selects any one of the vibrators 27-1 to 27-M as a destination of the sound signals entered from the sound input terminals 41-1 to 41-N, based on the control signal from the control portion 43, and controls the main processing portion 52 such that the sound signals are supplied to the selected vibrator.

The signal selection portion 51 supplies the sound signals entered from the sound input terminals 41-1 to 41-N, respectively, to the main processing portion 52.

The main processing portion 52 performs given processing on the sound signal supplied from the signal selection portion 51. The main processing portion 52 supplies the sound signal processed in the given manner to any one of the delay processing portions 53-1 to 53-M, under control of the signal selection portion 51. The delay processing portions 53-1 to 53-M perform signal processing on the vibrator that is the destination of the sound signal processed in the given manner.

With respect to the given processing performed by the main processing portion 52, the main processing portion 52 performs processing for removing noise from sound signals, for example. Furthermore, the main processing portion 52 may intact supply the sound signals entered from the sound input terminals 41-1 to 41-N, respectively, to anyone of the delay processing portions 53-1 to 53-M without performing the given processing under control of the signal selection portion 51, the delay processing portions 53-1 to 53-M performing signal processing on the vibrator that is the destination.

The delay processing portion 53-1 performs given processing on the sound signal supplied from the main processing portion 52, based on the control signal supplied from the control portion 43, and supplies the processed sound signal to the filtering processing portion 54-1.

With respect to the given processing performed by the delay processing portion 53-1, the delay processing portion 53-1 performs processing (delaying processing) for delaying the sound signal supplied from the main processing portion 52 by a given amount of delay, based on the control signal indicating an amount of delay corresponding to the viewing and listening position of the user, the amount of delay being supplied from the control portion 43. The delay processing portion 53-1 supplies the sound signal undergone the delaying processing to the filtering processing portion 54-1.

The delay processing portion 53-2 performs processing on the sound signal supplied from the main processing portion 52 to delay the sound signal, based on the control signal supplied from the control portion 43, in the same way as the delay processing portion 53-1, and supplies the sound signal undergone the delaying processing to the filtering processing portion 54-2.

Each of the delay processing portions 53-3 to 53-M performs processing for delaying a sound signal on the sound signal supplied from the main processing portion 52, based on the control signal supplied from the control portion 43, in the same way as the delay processing portion 53-1, and supplies the sound signal undergone the delaying processing to the filtering processing portion 54-3 to 54-M.

Details of the delay processing performed by the delay processing portions 53-1 to 53-M are described later.

The filtering processing portion 54-1 performs given processing on the sound signal supplied from the delay processing portion 53-1, based on the control signal supplied from the control portion 43, and supplies the sound signal undergone the given processing to the gain adjustment portion 55-1.

With respect to the given processing performed by the filtering processing portion 54-1, the filtering processing portion 54-1, for example, performs filtering processing for passing or blocking the sound signal in a given frequency band by a filter such as an FIR (finite impulse response) filter or IIR (infinite impulse response) filter, the sound signal being supplied from the delay processing portion 54-1, based on the control signal supplied from the control portion 43. The filtering processing portion 54-1 supplies the sound signal undergone the filtering processing to the gain adjustment portion 55-1.

In the same way as the filtering processing portion 54-1, the filtering processing portion 54-2 performs filtering processing for passing or blocking a sound signal in a given frequency band on the sound signal supplied from the delay processing portion 53-2, based on the control signal supplied from the control portion 43, and supplies the sound signal undergone the filtering processing to the gain adjustment portion 55-2.

In the same way as the filtering processing portion 54-1, the filtering processing portions 54-3 to 54-M perform filtering processing for passing or blocking a sound signal in a given frequency band on the sound signal supplied from the delay processing portions 53-3 to 53-M, respectively, based on the control signal supplied from the control portion 43, and supply the sound signal undergone the filtering processing to the gain adjustment portions 55-3 to 55-M, respectively.

The details of the filtering processing performed by the filtering processing portions 54-1 to 54-M, respectively, are described later.

The gain adjustment portion 55-1 performs given processing on the sound signal supplied from the filtering processing portion 54-1, based on the control signal supplied from the control portion 43, and supplies the processed sound signal to the vibrator 27-1.

With respect to the given processing performed by the gain adjustment portion 55-1, the gain adjustment portion 55-1, for example, adjusts the gain for the sound signal supplied from the filtering processing portion 54-1, based on the input sound signal, and based on the control signal supplied from the control portion 43, and performs processing for adjusting the gain to limit the range of levels of the output sound signal. The gain adjustment portion 55-1 supplies the sound signal undergone the gain adjustment processing to the vibrator 27-1.

In the same way as the gain adjustment portion 55-1, the gain adjustment portion 55-2 performs processing on the sound signal supplied from the filtering processing portion 54-2 for adjusting the gain to limit the range of levels of the output sound signal, based on the control signal supplied from the control portion 43, and supplies the sound signal undergone the gain-adjusting processing to the vibrator 27-2.

In the same way as the gain adjustment portion 55-1, each of the gain adjustment portions 55-3 to 55-M performs gain-adjusting processing on the sound signals supplied from the filtering processing portions 54-3 to 54-M, respectively, to limit the range of the output sound signal level, based on the control signal supplied from the control portion 43, and supplies the sound signals undergone the gain-adjusting processing to the vibrators 27-3 to 27-M, respectively.

Details of the gain-adjusting processing performed by the gain adjustment portions 55-3 to 55-M, respectively, are described later.

In this way, in the screen-type speaker system 21, the signal processing portion 42 performs given signal processing to thereby give weights to the sound signal supplied to the vibrator 27. It is possible to make the vibrating plate 26 output desired sounds.

In the following description, in a case where it is not necessary to discriminate between the individual delay processing portions 53-1 to 53-M, they are simply referred to as the delay processing portions 53. Where it is not necessary to discriminate between the individual filtering processing portions 54-1 to 54-M, they are simply referred to as the filtering processing portions 54. Where it is not necessary to discriminate between the individual gain adjustment portions 55-1 to 55-M, they are simply referred to as the gain adjustment portions 55. Where it is not necessary to discriminate between the individual sound input terminals 41-1 to 41-N, they are simply referred to as the sound input terminals 41.

In the above description of the example, the delay processing portion 53, filtering processing portion 54, and gain adjustment portion 55 perform their given processing on the sound signals supplied to the vibrators 27-1 to 27-M, respectively. In the present invention, it is not necessary to perform all the processing. For example, only delay processing on a sound signal may be performed by the delay processing portions 53.

In addition, in the description of the above example, for ease of illustration, the delay processing portions 53 are divided into the delay processing portions 53-1 to 53-M. The filtering processing portions 54 are divided into the filtering processing portions 54-1 to 54-M. The gain adjustment portion 55 is divided into the gain adjustment portions 55-1 to 55-M. In the present invention, they may be combined into one processing portion (e.g., delay processing portion 53, filtering processing portion 54, or gain adjustment portion 55), and processing may be performed.

Incidentally, plural microphones are connected with the sound input terminal 41 for entering sound signals to the signal processing portion 42, for example. The signal processing portion 42 performs given signal processing on a sound signal of sounds gathered by the microphones.

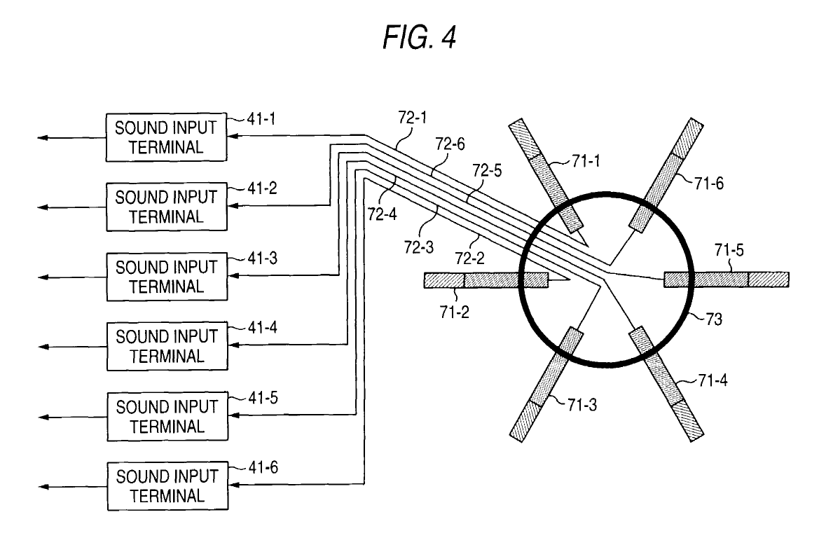

FIG. 4 is a diagram showing an example in which microphones are mounted in a case where the microphones are connected with the sound input terminal 41.

Microphones 71-1 to 71-6 are connected with the sound input terminals 41-1 to 41-6, respectively, via cables 72-1 to 72-6, respectively, as shown in the example of FIG. 4. The microphones 71-1 to 71-6 are held by a microphone stand 73.

The microphones 71-1 to 71-6 gather sounds and convert the gathered sounds into sound signals. The microphones 71-1 to 71-6 output the converted sound signals to the sound input terminals 41-1 to 41-6, respectively, via cables 72-1 to 72-6, respectively.

In this way, the microphones 71-1 to 71-6 are directed in 6 directions and thus sounds are gathered from the 6 directions, sound signals of the gathered sounds are entered into the signal processing portion 42 via cables 72-1 to 72-6 and via the sound input terminals 41-1 to 41-6, respectively.

In the example of FIG. 4, the 6 microphones are directed in 6 directions and gather sounds. In the present invention, sounds may be gathered from arbitrary directions using a plurality of microphones which are not limited to six in number. The microphones do not need to be arranged coaxially as shown in the example of FIG. 4. They may be arranged in arbitrary positions.

Furthermore, in the example of FIG. 4, the microphones 71-1 to 71-6 are connected with the sound input terminals 41-1 to 41-6, respectively, via the cables 72-1 to 72-6, respectively. Consequently, sounds gathered by the microphones can be processed in a real time. The present invention is not limited to this method. For example, a recorder or the like in which sounds recorded from microphones are recorded may be connected with the sound input terminal 41.

In the following description, in a case where it is not necessary to discriminate between the individual microphones 71-1 to 71-6, they are simply referred to as the microphones 71. Where it is not necessary to discriminate between the individual cables 72-1 to 72-6, they are simply referred to as the cables 72.

Incidentally, the screen-type speaker system 21 of the present invention can be built as a wall of a room. That is, by forming the screen-type speaker system 21 as a wall of a room, the wall acts to partition the room and can output sounds.

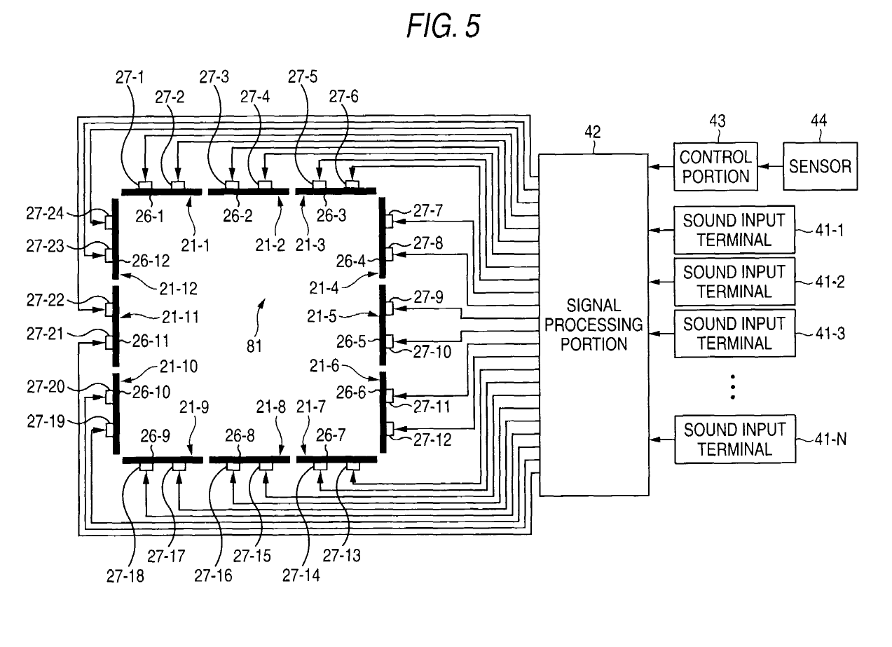

FIG. 5 is a diagram showing the structure of one embodiment of a room 81 to which the present invention is applied.

Those parts which are identical with their counterparts of FIG. 3 are indicated by the same reference numerals as in FIG. 3. Their description is (appropriately) omitted.

The room 81 is one example of a room of the present invention, the room being built by a plurality of screen-type speaker systems 21 becoming walls of a room.

That is, in the room 81 in which the screen-type speaker systems 21 are formed as walls, the walls act to partition the room. The walls can output sounds. In the example of FIG. 5, a figure as viewed from the upper side is shown. Spaces surrounded by the screen-type speaker systems 21-1 to 21-12 become the room 81.

FIG. 5 is a figure as viewed from the upper side of the room 81. In screen-type speaker systems 21-1 to 21-12, black squares represent vibrating plates. Two white squares mounted to the vibrating plates represent vibrators.

Furthermore, the room 81 is built so as to be surrounded on its four sides by screen-type speaker systems 21 and so the 12 screen-type speaker systems 21 are represented as if they were connected in a lateral direction. In practice, as shown in the example of FIG. 2, vibrating members are connected even in a vertical direction. The number of the vibrating members and the number of vibrators are arbitrary.

The room 81 is composed of four surfaces made of screen-type speaker systems 21-1 to 21-3, screen-type speaker systems 21-4 to 21-6, screen-type speaker systems 21-7 to 21-9, and screen-type speaker systems 21-10 to 21-12. That is, the four surfaces surrounding the four sides of the room 81 are each made of three screen-type speaker systems 21.

Each of the screen-type speaker systems 21-1 to 21-12 acts as speakers and also as screens (walls), in the same way as the screen-type speaker systems 21. That is, each of the screen-type speaker systems 21-1 to 21-12 can output various sounds by increasing vibrating members in a vertical direction or adjusting the thickness of the vibrating members.

In the description of the example of FIG. 5, the room 81 is surrounded by four surfaces. In the present invention, the number of the surfaces is not limited to four. It suffices that at least one surface is provided. Furthermore, in the above description, one surface is made of three screen-type speaker systems. In the present invention, the number of screen-type speaker systems forming one surface is not limited to three. It suffices that one screen-type speaker system is provided on at least one surface.

For example, microphones 71 are connected with sound input terminals 41-1 to 41-N, respectively. The sound input terminals 41-1 to 41-N supply sound signals, which are sound signals of sounds gathered by the microphones 71 and entered from the microphones 71, to the signal processing portion 42.

The signal processing portion 42 performs given processing such as the aforementioned delaying processing, filtering processing, or gain-adjusting processing on the sound signals entered from the sound input terminals 41-1 to 41-N under control of the control portion 43, and supply the sound signals obtained by the processing to the vibrators 27-1 to 27-24 mounted to the screen-type speaker systems 21-1 to 21-12, respectively.

The vibrators 27-1 to 27-24 are disposed at given positions according to the vibrational characteristics of the vibrating members 26-1 to 26-12, respectively. The vibrating members 26-1 to 26-12 are vibrated based on sound signals supplied from the signal processing portion 42.

The vibrating members 26-1 to 26-12 output sounds by being vibrated by the vibrators 27-1 to 27-24, respectively. That is, where the vibrating members 26-1 to 26-12 are configured to surround the four sides of the room 81 as shown in the example of FIG. 5, the whole room 81 becomes an acoustic field.

The control portion 43 controls signal processing performed by the signal processing portion 42 based on the position of the user present in the room 81 detected by the sensor 44 to thereby control the acoustic field so as to optimize the sounds at the position where the user is present.

In this way, the room 81 is formed by connecting the screen-type speaker systems 21-1 to 21-12 and so the acoustic field over the whole room can be controlled. Furthermore, the room 81 can output optimal sounds to the position where the user exists by detecting the position where the user exists by the sensor 44.

For example, where the user rotates the acoustic field in the room 81 by manipulating a touch panel remote controller, joystick, or the like, the room 81 can rotate the sound into the position at which the user is viewing and listening based on an acoustic field map by previously holding vibrator numbers, input signal numbers, amounts of delay, filter numbers, or gain values as the acoustic field map according to the position of the room 81.

One example of a method of rotating the acoustic field in the room 81 consists of causing a signal selection portion 51 in the signal processing portion 42 to select any one of the vibrators 27-1 to 27-24 as a target of sound signals entered from the sound input terminals 41-1 to 41-N, respectively, based on a control signal including information about an acoustic map supplied from the control portion 43 and providing control such that the sound signals are supplied to the selected vibrators. As a result, the room 81 can rotate with an angle of rotation of the number of sound signals entered from the sound input terminals 41-1 to 41-N, respectively.

In principle, the angle of rotation is reduced by performing given processing by means of the delay processing portion 53, filtering processing portion 54, and gain adjustment portion 55 based on a control signal including information about the acoustic map supplied from the control portion 43. Consequently, smoother rotation is enabled.

In the following description, in a case where it is not necessary to discriminate between the individual vibrators 27-1 to 27-24, they are simply referred to as the vibrators 27. Where it is not necessary to discriminate between the individual vibrating members 26-1 to 26-12, they are simply referred to as the vibrating members 26.

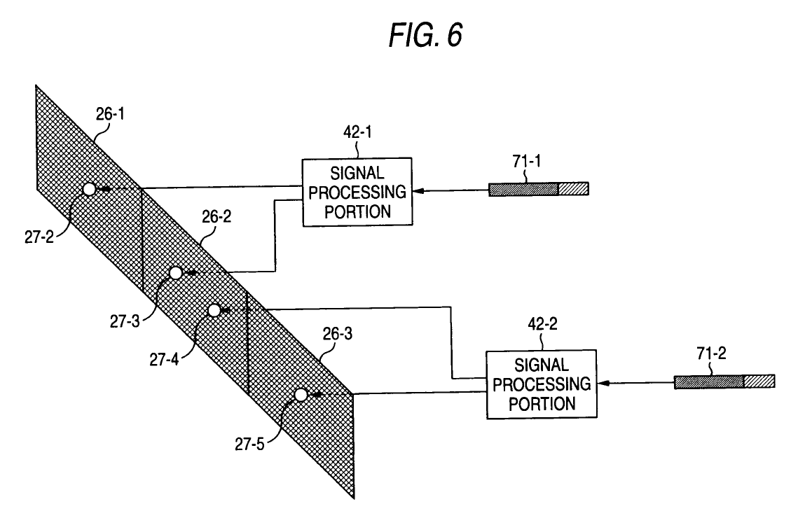

FIG. 6 is a diagram illustrating the vibrators 27 mounted to the vibrating members 26.

Those parts which are similar to their counterparts of FIGS. 2-5 are indicated by the same reference numerals. Their description is (appropriately) omitted. In the example of FIG. 6, to facilitate the illustration, a case where sounds are gathered by two microphones is described. Furthermore, sound signals of sounds gathered by the two microphones are represented as being entered into a signal processing portion 42-1 and a signal processing portion 42-2, respectively. Each of the signal processing portion 42-1 and signal processing portion 42-2 performs processing similarly to the aforementioned signal processing portion 42.

The signal processing portion 42-1 performs given processing on the sound signal entered from the microphone 71-1, and supplies the processed sound signal to the vibrator 27-2 and to the vibrator 27-3.

In the same way as the signal processing portion 42-1, the signal processing portion 42-2 performs given processing on the sound signal entered from the microphone 71-2, and supplies the processed sound signal to the vibrator 27-4 and to the vibrator 27-5.

The vibrators 27-2 to 27-5 are arranged in given positions of the vibrating members 26-1 to 26-3 and vibrate any one of the vibrating members 26-1 to 26-3, based on the sound signal supplied from any one of the signal processing portion 42-1 and signal processing portion 42-2, thus outputting sounds.

That is, two vibrators, i.e., vibrator 27-3 and vibrator 27-4, are mounted to the vibrating member 26-2 as in the example of FIG. 6. The vibrator 27-3 and vibrator 27-4 vibrate the vibrating member 26-2, thus outputting the sounds gathered by the microphone 71-1 and microphone 71-2, respectively.

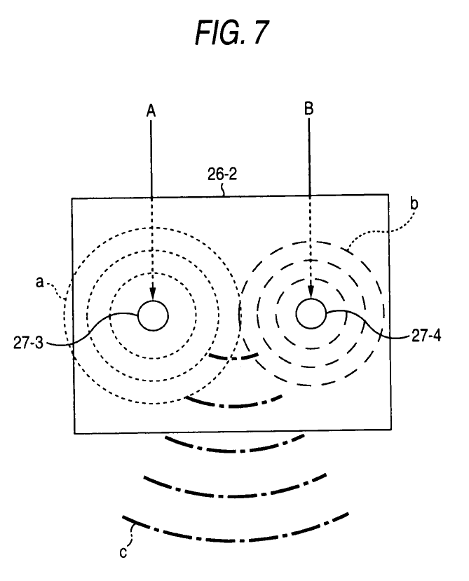

FIG. 7 is a diagram as viewed from the front side of the vibrating member 26-2 of FIG. 6.

The vibrator 27-3 vibrates the vibrating member 26-2 such as an oscillatory wave a indicated by the dotted lines of a triple circle centered at the vibrator 27-3 in FIG. 7 based on a sound signal A supplied from the signal processing portion 42-1, thus causing the vibrating member 26-2 to output sounds.

The vibrator 27-4 vibrates the vibrating member 26-2 such as an oscillatory wave b indicated by the dotted lines of a triple circle centered at the vibrator 27-4 of FIG. 7, for example, based on the sound signal B supplied from the signal processing portion 42-2, thus causing the vibrating member 26-2 to output sounds.

A composite wave c indicated by arcuate dotted lines in FIG. 7 is a wave produced by combining the oscillatory wave a and oscillator wave b on the vibrating member 26-2. That is, in the position where the composite wave c is produced, any vibrator for vibrating the vibrating member 26-2 is not mounted. It follows that the composite wave c is created from oscillatory waves produced by vibrating the vibrating member 26-2 by means of the vibrator 27-3 and the vibrator 27-4.

In other words, a vibrator exists at the position midway between the vibrator 27-3 and vibrator 27-4. The composite wave c is acoustic wave (sounds) (hereinafter may also be referred to as intermediate sound) produced from the vibrating member 26-2 by causing that virtual vibrator to vibrate the vibrating member 26-2.

In this way, in the present invention, intermediate sounds assumed to exist between microphones can be output together with sounds at the positions where the microphones are installed by combining sounds gathered by the plural microphones at arbitrary positions on the vibrating plate instead of mixing the sounds in the air. As a result, an acoustic field with realistic presence in which sound sources are not discretely arranged can be created.

In the description of the above example, two vibrators 27-3 and 27-4 are mounted to one vibrating member 26-2. It suffices that at least two vibrators 27 are mounted. The plural vibrators 27 are arranged at given positions according to the characteristics of the vibrating members 26.

With respect to the position at which the composite wave c is produced, the composite wave c can be produced at a desired position on the vibrating members 26 by causing the signal processing portion 42 to perform given processing. That is, the signal processing portion 42 can output intermediate sound from a desired position by supplying a sound signal undergone given processing to the vibrators 27 to cause the vibrating members 26 to output sounds physically, producing the composite wave c at a desired position.

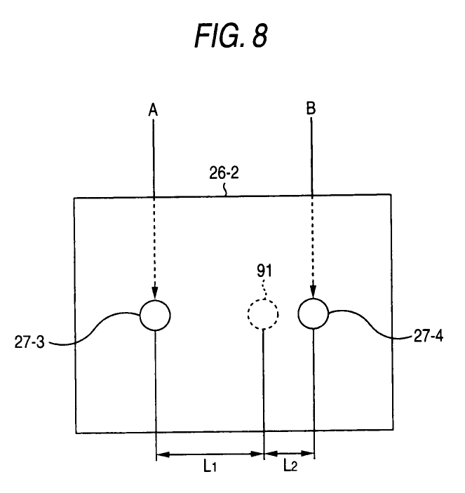

As shown in the example of FIG. 8, in a case where one wants to produce composite wave c from a position 91 which is at a distance of L1 from the vibrator 27-3 on the vibrating member 26-2 to the right as viewed in the figure and which is at a distance of L2 from the vibrator 27-4 to the left as viewed in the figure, the delay processing portion 53, filtering processing portion 54, and gain adjustment portion 55 of the signal processing portion 42 perform given signal processing on the sound signals of sounds gathered by the microphones 71.

The delay processing portion 53 performs delaying processing on a sound signal of sounds gathered by the microphones 71, based on a control signal indicating an amount of delay supplied from the control portion 43.

With respect to the control signal indicating the amount of delay supplied from the control portion 43, let D1 be the amount of delay introduced to the vibrator 27-3, and let D2 be the amount of delay introduced to the vibrator 27-4, for example. The amount of delay D1 and the amount of delay D2 are calculated from Eq. (1) and Eq. (2), respectively.

D1=(L2−L1)/2×v+α (1)

D2=(L1−L2)/2×v+α (2)

where v is the propagation velocity of the vibrating member 26 and α a indicates a value (adjusting value) for adjusting the amount of delay in a case where plural vibrating members 26 are provided. Since the propagation velocity v varies according to the material of the vibrating members 26, it is necessary to vary the value for each material. Where plural vibrating members 26 are provided, the amount of adjustment α is a value for adjusting the amount of delay between the vibrating members 26, for example, according to the position of the user.

That is, the control signal supplied from the control portion 43 contains information indicating the amount of delay D1 and the amount of delay D2. The delay processing portion 53 performs delaying processing on the sound signal gathered by the microphones 71, based on the amount of delay D1 and the amount of delay D2.

The filtering processing portion 54 performs filtering processing on sound signals of sounds gathered by the microphones 71 for passing or blocking sound signals in a given frequency band by a filter such as an FIR filter or IIR filter, based on the control signal supplied from the control portion 43.

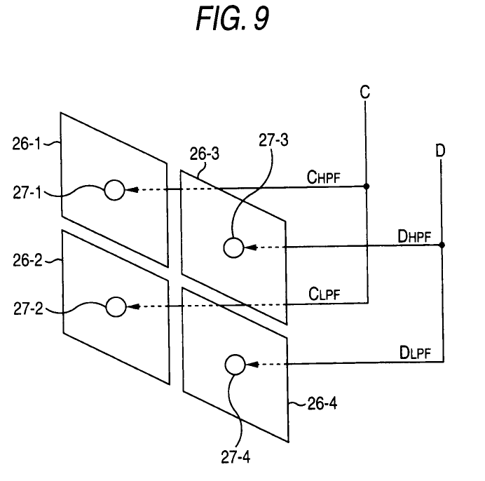

As shown in the example of FIG. 9, in a case where the vibrating members 26 are arrayed in two rows in a vertical direction (in FIG. 9, two in height×two in width), the filtering processing portion 54 causes the vibrating member 26-1 and the vibrating member 26-3 mounted at a high position to output high-frequency sounds (high-frequency sounds). The filtering processing portion causes the vibrating member 26-2 and vibrating member 26-4 mounted at a low position to output low-frequency sounds (low-frequency sounds).

In the example of FIG. 9, to facilitate understanding the explanation, 4 vibrating members arranged in 2 in height×2 in width are referred to as the vibrating members 26-1 to 26-4. The four vibrators mounted to the four vibrating members, respectively, are referred to as the vibrators 27-1 to 27-4 in the following description.

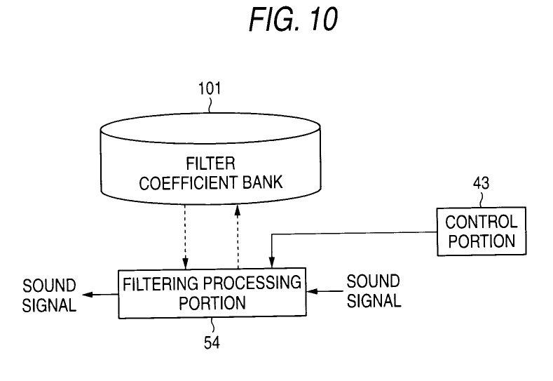

FIG. 10 is a diagram illustrating details of the filtering processing portion 54.

Those parts which are similar to their counterparts of FIG. 3 are indicated by the same symbols as in FIG. 3. Their description is (appropriately) omitted.

The filtering processing portion 54 obtains a filter coefficient, for example, of a high-pass filter (HPF), a low-pass filter (LPF), or a band-pass filter (BPF), or the like from a filter coefficient bank 101, based on the control signal supplied from the control portion 43. The filtering processing portion 54 performs filtering processing on a sound signal of sounds gathered by the microphones 71 according to the filter coefficient obtained from the filter coefficient bank 101.

That is, the filtering processing portion 54-1 passes only sound signals C of frequencies higher than the cutoff frequency of sounds gathered by the microphones 71 and attenuates sound signals C of frequencies lower than the cutoff frequency by a high-pass filter that is a coefficient obtained from the filter coefficient bank 101, based on the control signal supplied from the control portion 43, thus supplying filtered sound signal CHPF to the vibrator 27-1 (via the gain adjustment portion 55-1). The vibrator 27-1 vibrates the vibrating member 26-1 based on the sound signal CHPF supplied from the filtering processing portion 54-1, thus outputting high-frequency sounds.

Furthermore, the filtering processing portion 54-2 passes only sound signals C of frequencies lower than the cutoff frequency of sounds gathered by the microphones 71 and attenuates sound signals C of frequencies higher than the cutoff frequency by a low-pass filter that is a coefficient obtained from the filter coefficient bank 101, based on the control signal supplied from the control portion 43, thus supplying filtered sound signal CLPF to the vibrator 27-2 (via the gain adjustment portion 55-2). The vibrator 27-2 vibrates the vibrating member 26-2 based on the sound signal CLPF supplied from the filtering processing portion 54-2, thus outputting low-frequency sounds.

In addition, the filtering processing portion 54-3 performs filtering processing on sound signal D of sounds gathered by the microphones 71 based on the control signal supplied from the control portion 43 by a high-pass filter that is a coefficient acquired by the filter coefficient bank 101, and supplies the filtered sound signal DHPF to the vibrator 27-3 (via the gain adjustment portion 55-3), in the same way as the filtering processing portion 54-1. The vibrator 27-3 vibrates the vibrating member 26-3 based on the sound signal DHPF supplied from the filtering processing portion 54-3, thus outputting high-frequency sounds.

In the same way as the filtering processing portion 54-2, the filtering processing portion 54-4 performs filtering processing on sound signal D of sounds gathered by the microphones 71 based on the control signal supplied from the control portion 43 by a low-pass filter that is a coefficient acquired by the filter coefficient bank 101, and supplies the filtered sound signal DLPF to the vibrator 27-4 (via the gain adjustment portion 55-4). The vibrator 27-4 vibrates the vibrating member 26-4 based on the sound signal DLPF supplied from the filtering processing portion 54-4, thus outputting low-frequency sounds.

That is, where plural vibrating members 26 are utilized, the characteristics of the vibrating members 26 vary according to the thickness of the vibrating members 26, material, and the position at which the vibrating members 27 are mounted. Therefore, the filtering processing portion 54 performs given filtering processing on sound signals such that the filtering processing portion 54 is in charge of a band that is optimized for each vibrating member 26 (e.g., a band in which the volume is made greatest or a band in which the frequency characteristic is flattest), thus limiting the band of frequencies input to each vibrating member 26.

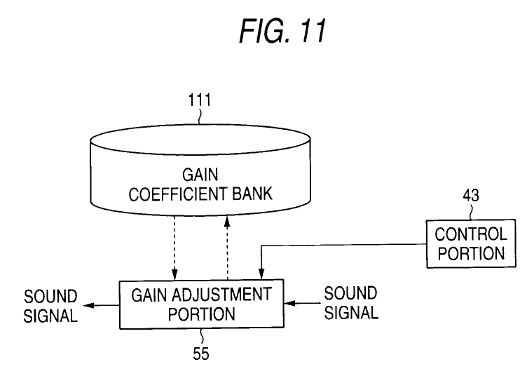

FIG. 11 is a diagram illustrating details of the gain adjustment portion 55.

Those parts similar to their counterparts of FIG. 3 are indicated by the same symbols as in FIG. 3 and their description is (appropriately) omitted.

The gain adjustment portion 55 gains a gain coefficient from again coefficient bank 111 based on a control signal supplied from the control portion 43. The gain adjustment portion 55 performs gain-adjusting processing on the sound signal of sounds gathered by the microphones 71 according to a gain coefficient obtained from the gain coefficient bank 111.

Gain coefficients include linearly varying coefficients, logarithmically varying coefficients, and nonlinearly varying coefficients, for example, according to the user's auditory characteristics. The gain adjustment portion 55 adjusts the gain for the input sound signal by these coefficients, thus limiting the range of levels of the output sound signal. The gain adjustment portion supplies the gain-adjusted sound signal to the vibrator 27. The vibrator 27 vibrates the vibrating member 26 based on the sound signal for which the gain has been adjusted, the sound signal being supplied from the gain adjustment portion 55. In this way, sounds are output.

That is, the vibration attenuation factor of the inside of the vibrating members 26 is different according to their material and so in a case where the vibration at a position 91 being a certain position is maximized and intermediate sound is created between sound signal A and sound signal B at the position 91 as shown in the example of FIG. 8, it follows that the gain is adjusted according to the attenuation factor of the material.

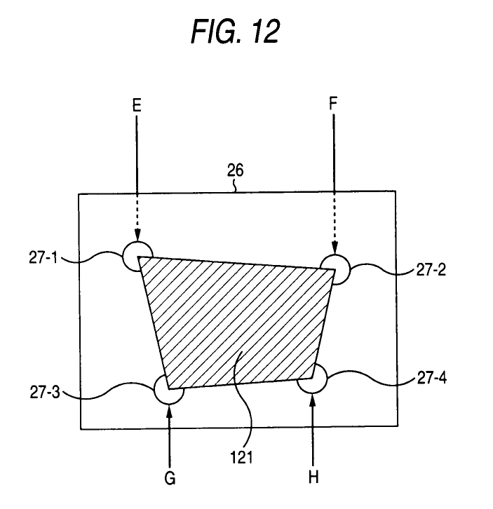

The plural vibrators 27 can be mounted to desired positions on the vibrating members 26. Therefore, where the vibrators 27-1 to 27-4 are mounted on the vibrating members 26 as shown in the example of FIG. 12, the signal processing portion 42 can provide control such that it outputs intermediate sound between plural sound signals from a surface 121 hatched in the figure centered at an arbitrary position on the vibrating members 26 by performing the aforementioned delay processing, filtering processing, or gain-adjusting processing.

That is, the signal processing portion 42 performs given processing such as delay processing, filtering processing, or gain-adjusting processing on sound signals E-H entered from the microphones 71-1 to 71-4, respectively, for example, and supplies the processed sound signals E-H to the vibrators 27-1 to 27-4, respectively.

The vibrators 27-1 to 27-4 vibrate the vibrating members 26 according to the sound signals E-H supplied from the signal processing portion 42, thus outputting intermediate sound from the surface 121.

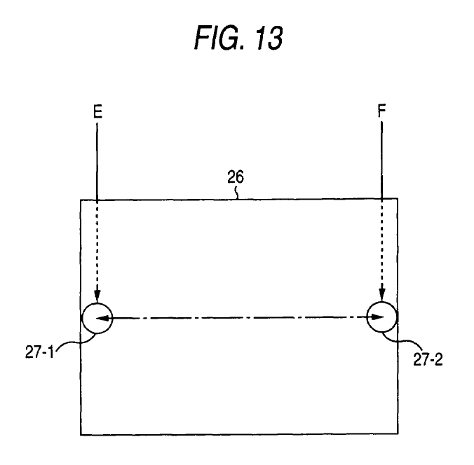

At this time, the vibrators 27-1 to 27-4 are preferably mounted to ends of the vibrating members 26. The range of the surface 121 of FIG. 12 can be enlarged, for example, by the vibrator 27-1 and vibrator 27-2 by mounting the vibrator 27-1 to the left end of the vibrating member 26 and mounting the vibrator 27-2 to the right end of the vibrator 26 as viewed in the figure as shown in the example of FIG. 13.

With respect to the vibrator 27-3 and vibrator 27-4, too, the range of the surface 121 centered at an arbitrary position on the vibrating member 26 can be enlarged by mounting the vibrators 27-3 and 27-4 to ends of the vibrating member 26.

In this way, the aforementioned rotation of the acoustic field can be performed more smoothly by providing control such that intermediate sound between plural signal sources (such as sound signals E-H) is output from the surface 121 centered at an arbitrary position on the vibrating member 26.

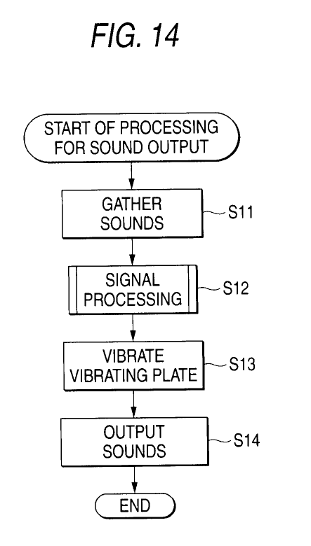

Processing for sound output performed by the screen-type speaker systems 21 is next described by referring to the flowchart of FIG. 14.

In step S11, each microphone 71 gathers sounds and converts the gathered sounds to a sound signal. The microphone 71 outputs the converted sound signal to the sound input terminal 41 via the cable 72, thus supplying the sound signal to the signal processing portion 42.

For example, in step S11, the 6 microphones 71-1 to 71-6 (FIG. 4) arranged coaxially gather sounds, convert the gathered sounds into sound signals, and supply the converted sound signals to the signal processing portion 42 via the cable 72 and sound input terminal 41.

In step S12, the signal processing portion 42 performs given processing on the sound signal which is a sound signal of sounds gathered by the microphones 71 and which is entered from the sound input terminal 41 under control of the control portion 43, and supplies the processed sound signal to the vibrator 26.

For example, in step S12, the signal processing portion 42 performs processing such as delay processing, filtering processing, gain-adjusting processing, or the like on the sound signals supplied from the microphones 71-1 to 71-6, respectively, and supply the sound signals of sounds gathered by the microphone 71-1 out of the signal-processed sound signals to the vibrator 27-1 under control of the control portion 43. Similarly, the signal processing portion 42 supplies signal-processed sound signals which are gathered by the microphones 71-2 to 71-6, respectively, under control of the control portion 43 to the vibrators 27-2 to 27-6, respectively.

That is, as shown in the example of FIG. 5, in a case where the screen-type speaker system 21-1 is composed of vibrating plate 26-1, vibrator 27-1, and vibrator 27-2; the screen-type speaker system 21-2 is composed of vibrating plate 26-2, vibrator 27-3, and vibrator 27-4; and the screen-type speaker system 21-3 is composed of vibrating plate 26-3, vibrator 27-5, and vibrator 27-6, the signal processing portion 42 supplies the signal-processed sound signals which are sound signals gathered by the microphones 71-1 to 71-6, respectively, to the vibrators 27-1 to 27-6, respectively, that are mounted to the vibrating plates 26-1 to 26-3. Details of the signal processing will be described later.

In step S13, the vibrator 27 vibrates the vibrating member 26 based on the sound signal supplied from the signal processing portion 42.

For example, in step S13, the vibrator 27-1 vibrates the vibrating member 26-1 based on the sound signal which is a sound signal of sounds gathered by the microphone 71-1 and which is supplied from the signal processing portion 42. Similarly, the vibrators 27-2 to 27-6 vibrate the vibrating members 26-1 to 26-3 on which the vibrators are mounted, respectively, based on sound signals of sounds which are gathered by the microphones 72-2 to 71-6, respectively, and which are supplied from the signal processing portion 42.

In step S14, the vibrating member 26 outputs sounds by being vibrated by the vibrator 27, thus terminating the processing.

For example, in step S14, the vibrating member 26-1 outputs sounds gathered by the microphone 71-1 and microphone 71-2, respectively, by being vibrated by the vibrator 27-1 and vibrator 27-2.

At this time, with respect to the vibrating member 26-1, the vibrator 27-1 is vibrated by sound signals gathered by the microphone 71-1. The vibrator 27-2 is vibrated by sound signals gathered by the microphone 71-2. Therefore, as described previously, these vibrations are combined on the vibrating plate 26-1. The vibrating plate 26-1 produces intermediate sound. That is, the intermediate sound is assumed to be gathered between the microphone 71-1 and the microphone 71-2 though the intermediate sound is not directly gathered by the microphones.

For example, the vibrating member 26-2 is vibrated by the vibrator 27-3 and the vibrator 27-4 in the same way as the vibrating member 26-1. Thus, the vibrating member 26-2 outputs sounds gathered by the microphone 71-3 and the microphone 71-4, respectively.

At this time, in the same way as the vibrating member 26-1, the vibrating member 26-2 produces intermediate sound assumed to be gathered between the microphone 71-3 and the microphone 71-4 because vibrations caused by the sound signal from the microphone 71-3 for the vibrator 27-3 and the vibrations caused by the sound signal from the microphone 71-4 for the vibrator 27-4 are combined on the vibrating member 26-2.

Furthermore, for example, the vibrating member 26-3 outputs sounds gathered by the microphone 71-5 and microphone 71-6, respectively, by being vibrated by the vibrator 27-5 and vibrator 27-6, respectively, in the same way as the vibrating member 26-1.

At this time, in the same way as the vibrating member 26-1, the vibrating member 26-3 produces intermediate sound assumed to be gathered between the microphone 71-5 and the microphone 71-6 because vibrations caused by the sound signal from the microphone 71-5 for the vibrator 27-5 and the vibrations caused by the sound signal from the microphone 71-6 for the vibrator 27-6 are combined on the vibrating member 26-3.

In this way, the screen-type speaker systems 21-1 to 21-3 can output sounds (intermediate sound) assumed to be gathered between the microphones, as well as sounds gathered by the microphones 71-1 to 71-6. As a result, in the present invention, an acoustic field with realistic presence in which sound sources such as microphones are not discretely arranged can be created.

In the example of FIG. 14, to facilitate understanding the explanation, sound signals of sounds gathered by the microphones 71-1 to 71-6, respectively, are explained as being supplied to the vibrators 27-1 to 27-6. The present invention is not limited to this. For example, sound signals of sounds gathered by the microphones 71-1 to 71-6, respectively, are made to correspond to the coaxially arranged microphones by supplying the sound signals to the vibrators 27-1 to 27-24, respectively, of FIG. 5.

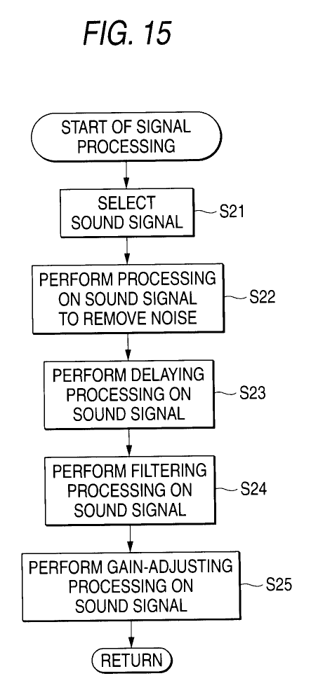

Details of the signal processing of step S12 of FIG. 14 are next described by referring to the flowchart of FIG. 15.

In step S21, the signal selection portion 51 selects the vibrator 27 as a destination of the sound signal entered from the sound input terminal 41, based on the control signal from the control portion 43, and controls the main processing portion 52 such that the sound signal is supplied to the selected vibrator 27.

For example, in step S21, the signal selection portion 51 selects the vibrators 27-1 to 27-6 as targets of sound signals, respectively, entered from the sound input terminals 41-1 to 41-6, respectively, based on the control signal from the control portion 43, and controls the main processing portion 52 such that the sound signals of sounds gathered by the microphones 71-1 to 71-6, respectively, are supplied to the selected vibrators 27-1 to 27-6, respectively.

In step S22, the main processing portion 52 performs given processing such as processing for removing noise in a sound signal on the sound signal supplied from the signal selection portion 51. The main processing portion 52 supplies the sound signal undergone the given processing to the delay processing portion 53 for performing signal processing on the vibrator becoming a target, based on control of the signal selection portion 51.

For example, in step S22, the main processing portion 52 performs processing for removing noise on the sound signals of sounds gathered by the microphones 71-1 to 71-6, respectively, supplied from the signal selection portion 51, and supplies the processed sound signal to the delay processing portions 53-1 to 53-6, respectively.

In step S23, the delay processing portion 53 performs processing for delaying a sound signal on the sound signal supplied from the main processing portion 52, based on the control signal supplied from the control portion 43, and supplies the sound signal undergone the delaying processing to the filtering processing portion 54.

For example, in step S23, the delay processing portions 53-1 to 53-6 perform delaying processing on sound signals of sounds gathered by the microphones 71-1 to 71-6, respectively, supplied from the main processing portion 52, based on the control signal supplied from the control portion 43, and supplies sound signals undergone the delaying processing to the filtering processing portions 54-1 to 54-6, respectively.

In step S24, the filtering processing portion 54 performs filtering processing for passing or blocking sound signals in a given frequency band on the sound signal supplied from the delay processing portions 53, based on the control signal supplied from the control portion 43, and supplies the filtered sound signal to the gain adjustment portion 55.

For example, in step S24, the filtering processing portions 54-1 to 54-6 perform filtering processing on sound signals supplied from the delay processing portions 53-1 to 53-6, respectively, based on the control signal supplied from the control portion 43, and supply the filtered sound signals to the gain adjustment portions 55-1 to 55-6, respectively.

In step S25, the gain adjustment portion 55 performs gain-adjusting processing for limiting the range of the output sound signal level on the sound signal supplied from the filtering processing portion 54, based on the control signal supplied from the control portion 43, supplies the sound signal undergone the gain-adjusting processing to the vibrator 27, and returns program control to the processing of step S12 of FIG. 14, thus performing the processing of step S13 and the following processing.

For example, in step S25, the gain adjustment portions 55-1 to 55-6 perform gain-adjusting processing on the sound signals supplied from the filtering processing portions 54-1 to 54-6, respectively, based on the control signal supplied from the control portion 43, and supply the sound signals undergone the gain-adjusting processing to the vibrators 27-1 to 27-6, respectively.

In this way, the signal processing portion 42 can perform different signal processing on each sound signal supplied to the vibrators 27 and, therefore, more appropriate sound signals can be supplied to the vibrators 27 to produce intermediate sound.

As described so far, according to the present invention, individual portions of a wide range of a vibrating member can be appropriately vibrated to produce sounds from these portions. As a result, sounds with more realistic presence can be output.

Furthermore, according to the present invention, sounds gathered with two or more microphones are not mixed in the air but combined on a vibrating member. Consequently, sounds assumed to exist between microphones can be output in addition to sounds at the sound-gathering positions. In addition, according to the present invention, in a case where walls of a room are constituted by connecting together them by screen-type speaker systems, an acoustic field with realistic presence can be created irrespective of the viewing and listening position of the user, by detecting the user's viewing and listening position by sensors.

In addition, according to the present invention, a so-called sweet spot can be widened by surrounding the walls of the room with screen-type speaker systems and synthesizing sounds on the vibrating plate. In addition, a hole-in-the-middle can be prevented.

The aforementioned sequence of processing steps can be executed by hardware. It can also be executed by software. Where the sequence of processing steps is executed by software, a program forming the software is installed from a recording medium either into a computer incorporated in dedicated hardware or into a general-purpose personal computer, for example, capable of executing various functions by installing various programs.

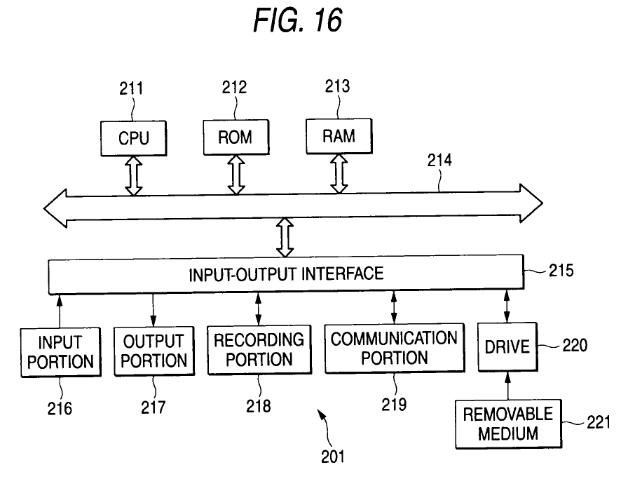

FIG. 16 is a diagram showing an example of structure of the inside of a general-purpose personal computer 201. A CPU (central processing unit) 211 performs various kinds of processing according to a program stored in a ROM (read only memory) 212 or according to a program loaded from a storage portion 218 to a RAM (random access memory) 213. Data necessary for the CPU 211 to execute various kinds of processing are also appropriately stored in the RAM 213.

The CPU 211, ROM 212, and RAM 213 are interconnected via a bus 214. An input-output interface 215 is also connected with the bus 214.

An input portion 216 composed of buttons, switches, a keyboard, and a mouse, a display device such as a CRT (cathode-ray tube) or LCD (liquid crystal display), an output portion 217 composed of speakers and soon, the recording portion 218 composed of a hard disk or the like, and a communication portion 219 composed of a modem, a terminal adapter, and so on are connected with the input-output interface 215. The communication portion 219 performs communication processing via a network including the Internet.

As the need arises, a drive 220 is connected with the input-output interface 215. A removable medium 211 consisting of a magnetic disk, optical disk, magnetooptical disk, semiconductor memory, or the like is appropriately installed in the drive. A computer program that is read from it is installed in the recording portion 218.

A recording medium for recording a program that is installed in a computer and made executable by the computer is made of the removable medium 211 which is distributed to offer a program to users apart from the body of the apparatus as shown in FIG. 16 and which consists of a magnetic disk (including a flexible disk), optical disk (including CD-ROM (compact disc-read only memory), DVD (digital versatile disc)), a magnetooptical disc (including MD (Mini-Disc) (trademark registered)), a semiconductor memory, or the like in which a program is recorded. In addition, the recording medium is made of a hard disc or the like contained in the ROM 212 or recording portion 218 in which a program is recorded. The hard disc that is in a state in which the disc has been previously incorporated in the body of the apparatus is offered to the user.

Furthermore, the program for executing the aforementioned sequence of processing steps may be installed in the computer via an interface such as a router, modem, or the like as the need arises or via a wired or wireless communication medium such as a local area network, the Internet, or a digital satellite broadcast.

In this description, the steps stating the program stored in the recording medium include processing that is of course performed in a time sequential manner in the described order. The steps are not always required to be processed in a time sequential manner. They may also be carried out in a parallel manner or individually.

Moreover, the embodiments of the present invention are not limited to the above embodiments. Various changes and modifications are possible within the range not deviating from the gist of the present invention.

1. A sound output device for converting a first sound signal and a second sound signal into sounds to output the sounds, the sound output device comprising:
a vibrating member for outputting the sounds by vibrating;
a first vibrator mounted to the vibrating member and vibrating the vibrating member based on the first sound signal; and
a second vibrator mounted to the vibrating plate such that a given space is formed between the first vibrator and the second vibrator, the second vibrator vibrating the vibrating member based on the second sound signal.

2. A sound output device of claim 1, further including processing means for performing given signal processing on each of the first sound signal and the second sound signal.

3. A sound out put device of claim 2, wherein the processing means includes delaying processing means for delaying the first sound signal and the second sound signal, respectively.

4. A sound output device of claim 2, wherein the processing means has filtering processing means for passing certain frequency-band components out of components of the first sound signal and the second sound signal.

5. A sound output device of claim 2, wherein the processing means includes gain adjustment processing means for adjusting gains for the first sound signal and the second sound signal.

6. A sound output method for a sound output device for converting a first sound signal and a second sound signal into sounds and outputting them, the sound output method comprising the steps of:
arranging a vibrating member for outputting the sounds by vibrating;
arranging a first vibrator mounted to the vibrating member and vibrating the vibrating member based on the first sound signal;
arranging a second vibrator mounted to the vibrating plate such that a given space is formed between the first vibrator and the second vibrator, the second vibrator vibrating the vibrating member based on the second sound signal; and
performing given signal processing on the first sound signal and on the second sound signal separately.

7. A program for causing a computer to perform processing for outputting sounds, the computer being in or for a sound output device for converting a first sound signal and a second sound signal into sounds and outputting them, the program performing the steps of:
arranging a vibrating member for outputting the sounds by vibrating;
arranging a first vibrator mounted to the vibrating member and vibrating the vibrating member based on the first sound signal;
arranging a second vibrator mounted to the vibrating plate such that a given space is formed between the first vibrator and the second vibrator, the second vibrator vibrating the vibrating member based on the second sound signal; and
performing given signal processing on the first sound signal and on the second sound signal separately.

8. A room partitioned by a wall consisting of a vibrating member for outputting the sounds by vibrating, a first vibrator mounted to the vibrating member and vibrating the vibrating member based on a first sound signal, and a second vibrator mounted to the vibrating plate such that a given space is formed between the first vibrator and the second vibrator and vibrating the vibrating member based on a second sound signal.

9. A room of claim 8, further including processing means for performing given signal processing on the first sound signal and on the second sound signal separately.

10. A room of claim 9, further including detection means for detecting a user's position, and wherein the processing means performs given signal processing on the first sound signal and on the second sound signal separately based on the detected position.

11. A room of claim 8, wherein the room is surrounded on its four sides by the wall.
